(19) United States
(12) Patent Application Publication
(10) Pub. No.: US 2014/0131408 A1
(43) Pub. Date: May 15, 2014

(54) SUPPORT APPARATUS FOR PERSONAL ELECTRONIC DEVICE AND METHOD OF USING THE SAME

(71) Applicants: Daniel Kirk Brittain, Hickory, NC (US); John Preston Anthony, Charlotte, NC (US); Sidney Gaines Cash, Winter Park, FL (US)

(72) Inventors: Daniel Kirk Brittain, Hickory, NC (US); John Preston Anthony, Charlotte, NC (US); Sidney Gaines Cash, Winter Park, FL (US)

(21) Appl. No.: 14/076,242

(22) Filed: Nov. 10, 2013

Related U.S. Application Data
(60) Provisional application No. 61/724,914, filed on Nov. 10, 2012.

(51) Int. Cl. F16M 13/02

(52) U.S. Cl. CPC F16M 13/022
USPC 224/570; 29/428

(57) ABSTRACT

An apparatus for securing a personal electronic device to a solid support structure and a method of using the same is provided. The apparatus generally comprises a platform for supporting a personal electronic device such as a smart phone or tablet and a means for securing a personal device to said platform. The apparatus may further comprise a means of securing the apparatus to a transport carrier, such as a shopping cart or bicycle.

### CROSS REFERENCE TO RELATED APPLICATIONS

This application claims priority to U.S. Provisional Patent Application Ser. No 61/724,914 filed Nov. 10, 2012. The disclosure of U.S. Provisional Patent Application 61/724,914 is incorporated by reference herein in its entirety.

### FIELD OF THE INVENTION

The present invention generally relates to the field of structures for supporting media devices such as personal electronic devices and methods of using the same.

### BACKGROUND OF THE INVENTION

With the increasing popularity and increasing processing power of portable electronic devices or personal data assistants (PDA), users have begun to use these devices more than ever. Examples of popular PDAs include mobile phones, smart phones, and tablets, such as the Apple iPad. Modem PDAs, in addition to having the capability of making phone calls, can also act as portable computing platforms, navigation systems, and even consumer assistants, thereby making the mobile phone an extremely convenient device to carry with the user at all times.

For example, modern PDAs have the capacity to connect to the interact at high speeds and view advertisements and shopping promotions from retailers. A consumer pushing a cart through a retail outlet may desire to have such promotions delivered directly to their PDA as they shop, thus improving their shopping experience and possibly saving them money in the process. Likewise, retailers may desire to target the consumer's PDA with advertisements that may attract the consumer to specific product offerings. A consumer's PDA may be detected as they enter a retail establishment automatically triggering the interaction and information exchange described above.

When pushing a cart through a retail outlet, it would be convenient to mount the PDA in a cradle for positioning the PDA in a location that is easy to access and easy to read the display of the mobile phone. Therefore a cradle for holding the mobile phone has become a popular accessory, not only for mobile phones, but for other portable electronic devices as well.

However, conventional cradles suffer from the drawbacks of not being adaptable enough to receive PDAs with slightly different dimensions while at the same time retaining PDA in the cradle securely. One notable problem is when a user installs a protective cover around the outer surface of the PDA. This protective cover, often having rubber material, increases the dimensions of the phone on all sides of the phone. Other conventional cradles have not been adaptable to shopping cans, such as those used in grocery stores. Thus, it would be desirable to have a PDA cradle that is adaptable to receive and secure PDAs of varying dimensions, attachable to shopping carts, and adjustable to allow convenient screen viewing at different angles.

### BRIEF DESCRIPTION OF THE FIGURES

Representative embodiments of the invention are disclosed in more detail with reference to the following figures. Like reference numerals designate corresponding parts or steps throughout the different views.

FIG. 1 shows a detailed break out of the individual components of an embodiment the apparatus for supporting a personal electronic device of the present invention.

FIG. 2 shows an offset angled view of an embodiment of the apparatus for supporting a personal electronic device of the present invention.

FIG. 3A shows a top view of an embodiment of the platform of the present invention.

FIG. 3B shoes a bottom view of an embodiment of the platform of the present invention.

FIG. 4 shows a break out of the individual components of an embodiment of the present invention.

FIG. 5 shows a side view of an embodiment apparatus for supporting a personal electronic device of the present invention.

FIG. 6A shows a top view of an embodiment of the platform of the present invention,

FIG. 6B shoes a bottom view of an embodiment of the platform of the present invention.

### SUMMARY OF THE INVENTION

The present invention relates to an apparatus for securing a personal electronic device to a solid support structure and a method of using the same. The apparatus generally comprises a platform for supporting a personal electronic device such as a smart phone or tablet and a means for securing a personal device to said platform. The apparatus may further comprise a means of securing the apparatus to a transport carrier, such as a shopping cart or bicycle.

in one embodiment, in addition to the platform, the apparatus may further comprise one or more support members for example, clamps, braces, brackets, clips and/or tabs. For example, in one embodiment, the platform comprises a first clamp and a second clamp. In another embodiment, said platform may comprise one or more braces for prevention of unwanted lateral movement, of a personal electronic device, for example, tabs for preventing unwanted vertical movement of the personal electronic device. In yet another embodiment, the platform comprises a single clip for supporting the personal electronic device. Said support member may further comprise one or more arms for the prevention of unwanted personal electronic device movement which may engage the top face of the personal electronic device to hold the device securely against the platform.

In another embodiment, the platform comprises a sliding member and a cavity for receiving said sliding member. In one embodiment, wherein the platform comprises a sliding member, the cavity for receiving, said sliding member may comprise a retraction member and a retraction member housing whereby said retraction member is engaged to the sliding member exerting tension on the same. In embodiments comprising a sliding member, said sliding member may also comprise support members, such as for example, clamps, braces and/or tabs.

In another embodiment, the apparatus may comprise one or more buttons which may be static or movable and spring actuated. In a separate embodiment, said one or more buttons extend through complementary one or more apertures formed within the platform.

In yet another embodiment, the apparatus may comprise a clamp assembly wherein the apparatus may be attached to a transport carrier.

The platform may be static or rotate about an axis of rotation. In one embodiment, the axis of rotation is defined by a central bore and a pivot member extending through said first clamp into said cavity which houses said sliding member,

### DETAILED DESCRIPTION OF THE EXEMPLARY EMBODIMENTS

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” or “in some embodiments” or “in a preferred embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise, in addition, throughout the specification, the meaning of “a,” “an,” and “the” include plural references The meaning of “in” includes “in” and “on.”

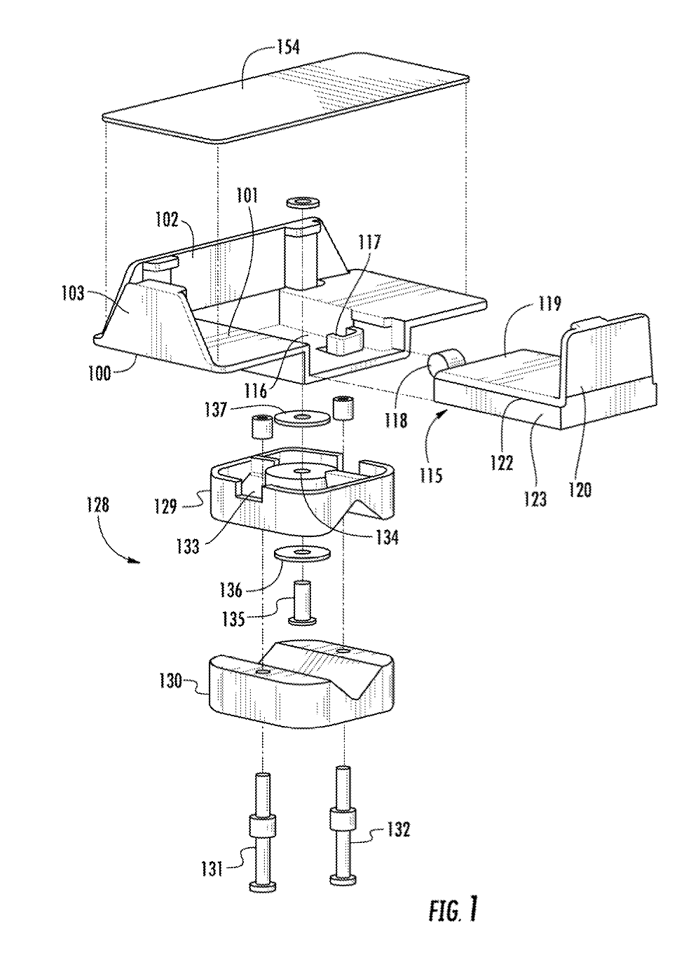

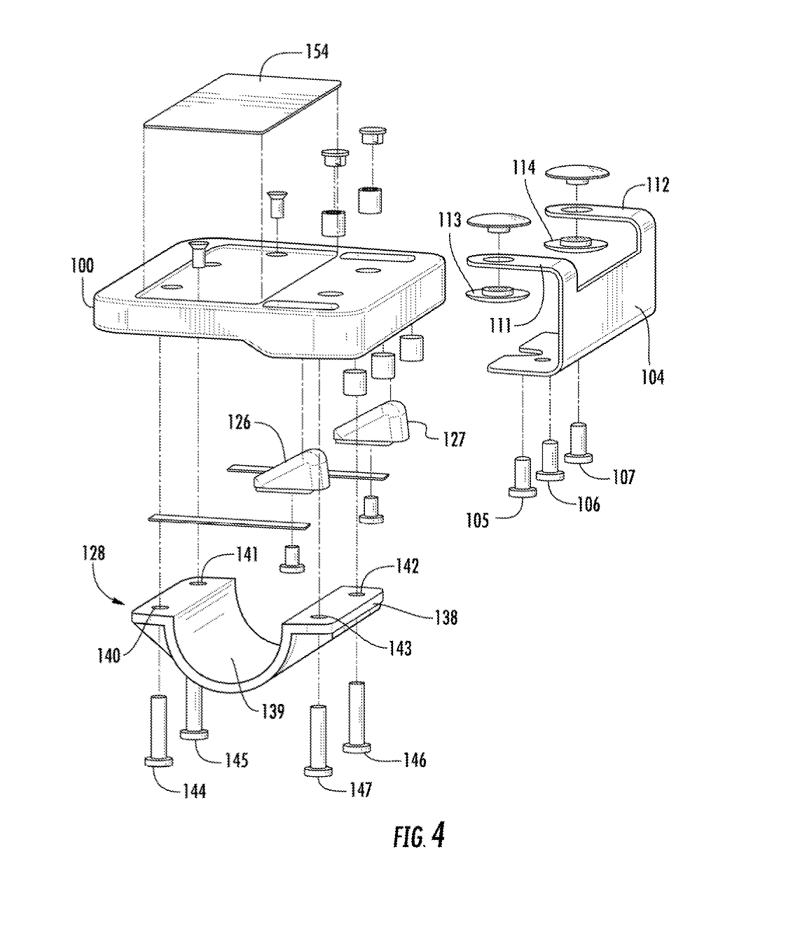

Referring now generally to FIGS. 1 and 4, the present invention generally comprises a platform 100 for supporting a personal electronic device such as a smart phone or tablet, a means for securing a personal device to said platform, and a means of securing the apparatus to a transport carrier, such as a shopping cart or bicycle.

In addition to the platform 100, the apparatus may further comprise one or more support structures for the personal electronic device. Referring to FIG. 1, for example, in one embodiment, platform 100 may comprise a base support surface 101 upon which a personal electronic device rests. Additionally, platform 100 may comprise one or more side braces or bracket structures designed to prevent the personal electronic device from disengaging from platform 100 and falling to the floor causing unwanted damage to the PDA and a poor user experience. In the embodiment shown in FIG. 1, platform 100 comprises two side braces, a first side brace 102 and a second side brace 103. Said side braces may be adjustable or static. In the embodiment illustrated in FIG. 1, first side brace 102 is static and supports the lateral side of the personal electronic device. Similarly, second side brace 103 may be static and support either the top end or bottom end of the personal electronic device.

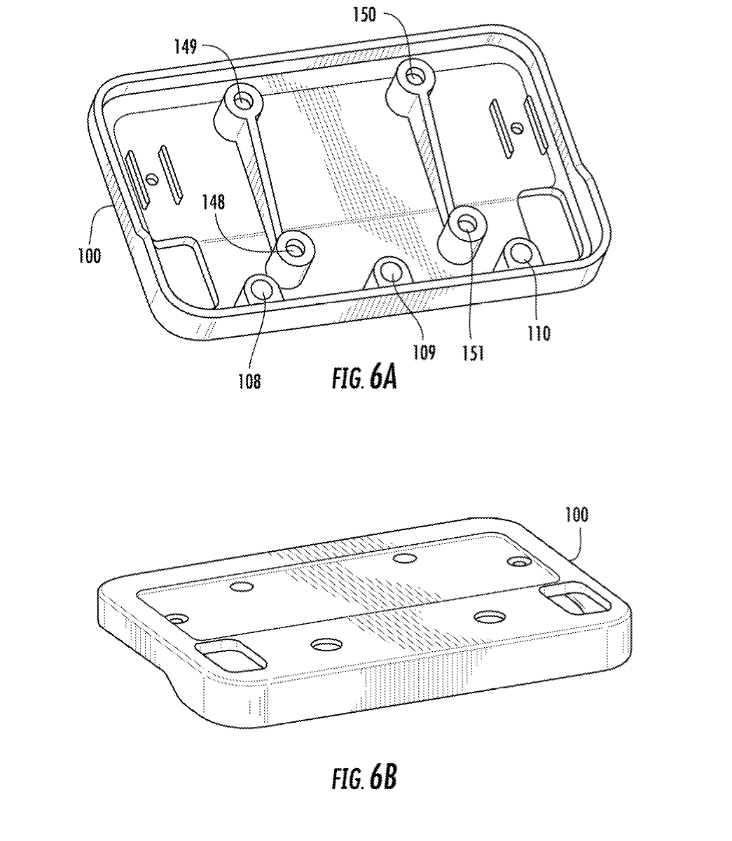

In another embodiment shown in FIG. 4, platform 100 may comprise a single brace 104 which, in this example, is detachably engaged to said platform 100. Referring to FIG. 4, brace 104 is connected to the bottom surface of platform 100 via securing members 105, 106, 107 which engage matching bores 108, 109, 110 manufactured into the platform's bottom surface (see FIG. 6A). In one embodiment, said bores may further comprise threaded inserts which receive securing members, such as a threaded screw or bolt.

With continued reference to FIG. 4, brace 104 may further comprise one or more arms, for example, 111 and 112, as shown in FIG. 4. In one embodiment, said arms extend over the front substantially flat surface of a personal electronic device and offer further support to said device as it rests in the apparatus. In some embodiments, arms may additionally comprise tabs or buttons, 113 and 114, which contact the front surface of the personal electronic device. The buttons may be designed in such a manner to avoid scratching the upper surface of the personal electronic device in use.

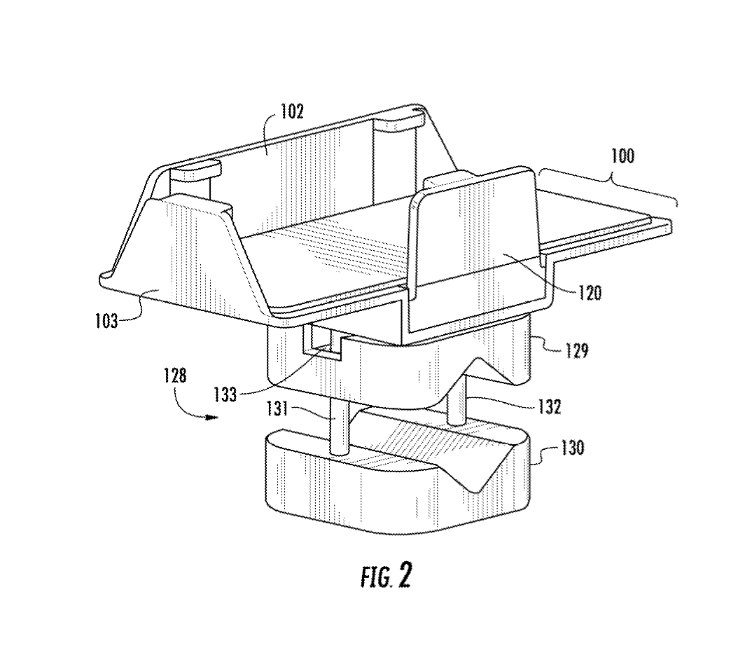

The apparatus may additionally comprise a sliding member 115 as shown in FIGS. 1 and 2. In one embodiment, base support surface 101 comprises a cavity 116 for receiving said sliding member 115. And cavity 116 may further comprise a housing 117 for insertion and retention of retraction member 118. In one embodiment, retraction member 118 may be a constant force spring, torsion spring, compression spring, coil, or the like.

As discussed above and with continued reference to FIG. 1, sliding member 115 may be received by cavity 116. Retraction member 118 may comprise a retention element that engages sliding member 115. For example, in one embodiment, retention element is a tab at a first end of retraction member 118. Retention element may be secured to sliding member 115 through a locking member located on sliding member 115. Retraction member 118 engages sliding member 115 such that as sliding member 115 is pulled away from platform 100 toward an open position retraction member 118 extends and creating tension on retraction member 118 causing sliding member 115 to resist further motion. As long as force is applied to sliding member 115 to bold it in an open position or as long as a personal electronic device or other object. is resting on platform 100 sliding member 115 cannot completely close. The tension applied to sliding member 115 by retraction member 118 and engagement of sliding member 115 with a personal electronic device secures the personal electronic device to platform 100

Referring to FIG. 1, sliding member 115 may also comprise a base member 119 and also one or more side braces, for example 120. Base member 119 may be substantially the same length and width as cavity 116 as it is designed to insert into cavity 116. Base member 119 may comprise one or more features along one or more of its lateral faces to prevent unwanted movement of sliding member 115 once inserted into cavity 116. For example, as depicted in FIG. 1, lateral face 121 may comprise a furrow 122 extending the length of lateral face 123. Cavity 116 may comprise ridge 124 for engagement with furrow 122 as sliding member 115 is inserted into cavity 116. In another embodiment, lateral face 121 is stepped and cavity 116 comprises a ridge which engages with the step preventing sliding member 115 from being removed from cavity 116 without first sliding it out of the cavity.

In one embodiment, one or more sides of base member 119 are open. For example, first side 125 (not shown in figures) of base member 119 is open such that base member 119 passes over housing 117 of cavity 116 as sliding member 115 inserts into cavity 116.

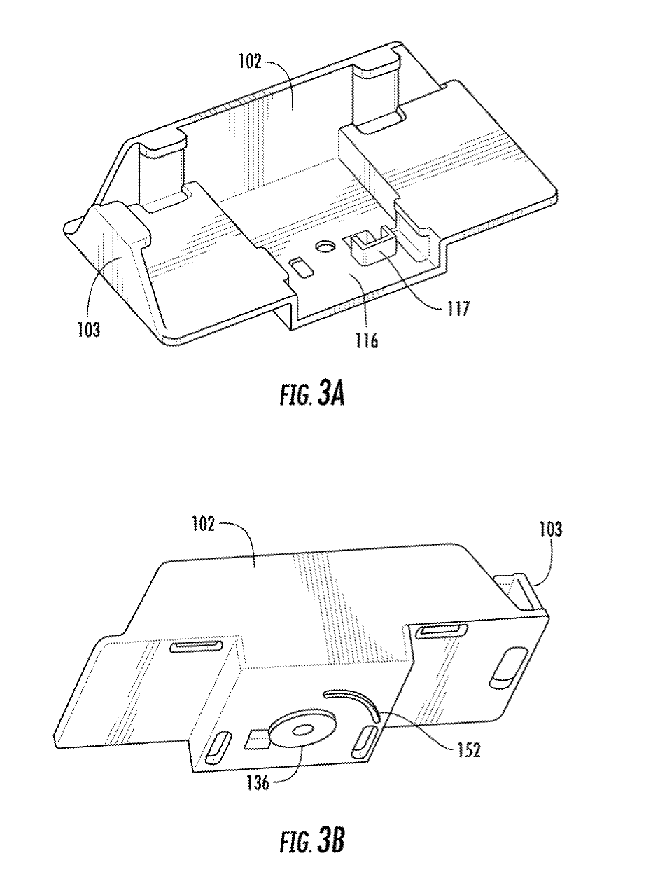

In another embodiment, first side brace 102, second side brace 103, and site brace 120 on sliding member 115 may have one or more tabs (as shown in FIGS. 1-3A to provide additional security and support to the personal electronic device, for example preventing the device from bouncing off the platform 100 and out of the cradle.

One or ordinary skill in the art will understand that side braces referred to herein may be any height as long as their dimensions ensure adequate lateral support for the personal electronic device placed in the cradle. However, it has been determined that certain dimensions are preferred and function optimally. For example in the embodiment shown in FIG. 1 comprising a sliding member, the height of first side brace 102, second side brace 103, and side brace 120 is between about 0.625 inches and about 0.750 inches compatible with most personal electronic devices on the market today. In another embodiment, the height of first side brace 102, second side brace 103, and side brace 120 is about 0.625 inches and in another embodiment the height is about 0.625 inches. The height of first side brace 102, second side brace 103, and side brace 120 must be sufficient to allow securing tabs to engage the top surface of the personal electronic device held within the cradle. It should be recognized that these dimensions are subject to change as personal electronic devices change size and shape. For instance, in the embodiment shown in FIG. 4, wherein the single side brace 104 wraps underneath and engages the back surface of the platform 100, the height of said side brace 104 from the surface that engages platform 100 to the upper arm surface is about 1.3 inches.

In the embodiment shown in FIG. 1 with a sliding member 115, the distance between first side brace 102 and side brace 120 of sliding member 115 is important for the purposes of the present invention since this distance defines the space in which the personal electronic device rests. In one embodiment, when sliding member 115 is in a fully closed position within cavity 116, the distance between first side brace 102 and side brace 120 is between about 2.170 and about 2.175 inches. In another embodiment, this distance between first side brace 6 and side brace 12 is about 2.170 inches and, in yet another embodiment, this distance is about 2.175 inches. When sliding member 115 is in a fully extended open position, in one embodiment, the distance between first side brace 102 and side brace 120 is about 2.975 inches. Thus in the present embodiment, sliding member 115 is permitted to extend or travel between about 0.8 to about 0.85 inches within cavity 116 as sliding member 115 is opened.

The apparatus may additionally comprise a single or a plurality of button elements on the platform to further support a user's personal electronic device from underneath the device.

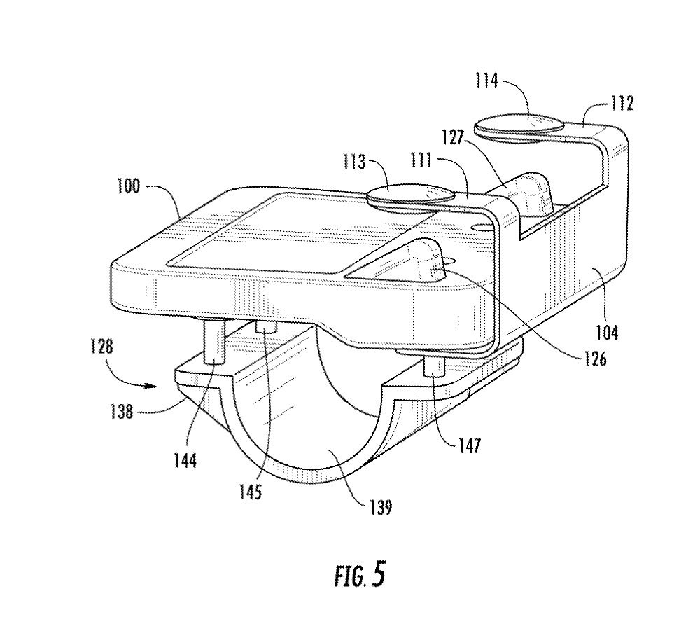

Referring now to FIGS. 4 and 5, button elements 126 and 127 are shown extending upward from the platform's surface. In this embodiment, button elements 126 and 127 are connected to platform 100 by rivets or the like to the underside of the platform. Button elements 126 and 127 may furthermore be spring actuated creating a resistance to downward pressure on said buttons applied by, for example, the weight of a personal electronic device or a user's finger. With said spring actuation, said buttons return to their uppermost position upon pressure release or removal of the weight. In the embodiment depicted in FIG. 1, buttons 113 and 114 on arms 111 and 112 combined with button elements 126 and 127, produce a substantial degree of constricting pressure on the front and back surfaces of a personal electronic device placed in the cradle or apparatus working in a concerted fashion to assist in securing the device within the cradle and prevent unwanted movement.

The apparatus may further comprise a clamp assembly to secure the apparatus to a transport carder, such as a shopping cart or a bicycle. In one embodiment, the apparatus is designed to be secured to a handlebar, such as the cylindrical handlebar of a shopping cart. For example, in the embodiment shown in FIG. 1, the clamp assembly 128 comprises a plurality of clamps, specifically a first clamp 129, a second clamp 130, and one or more securing members which secure the damps to one another and to the platform. In the embodiment illustrated in FIG. 1, clamp assembly 128 comprises two securing members 131 and 132 which, in this embodiment, are depicted as screws and threaded rivets or bolts. In one embodiment, said securing members 131 and 132 may utilize tamper resistant or tamper proof screws, for example, requiring a special tool to loosen or tighten. Securing members 131 and 132 secure first clamp 129 and second clamp 130 together to a support structure such as a handle bar on a grocery cart and may be adjustable to tighten or loosen the clamp assembly 128 to said support structure as needed. In the embodiment depicted in FIG. 1, first clamp 129 and second clamp 130 may comprise matching bore holes through which securing members 131 and 132 extend. Additionally, first clamp 129 may comprise housing 133 for receiving the rivets or bolts forming a part of securing members 131 and 132.

With continued reference to the embodiment illustrated in FIG. 1, first clamp 129 of damping assembly 128 may comprise a central bore 134 defining an axis of rotation. In one embodiment, a pivot member 135 may be inserted through central bore 134 in first clamp 129. Pivot member 135 may also extend through a first washer 136 and second washer 137 positioned on opposite sides of first clamp 129. Pivot member 135 may furthermore engage the underside of cavity 116 in a manner that promotes the rotation of platform 1 about the axis of rotation defined by central bore 134 and pivot member 135. As depicted in the embodiment shown in FIG. 1, cavity 116 may receive pivot member 135 through bore 134. Pivot member 135 may be secured to platform 100 by any structure that hampers disconnection of platform 100 from pivot member 135 while allowing rotation of platform 100 about the axis of rotation. In one embodiment, pivot member 135 may be secured to platform 100 by a pop rivet or the like.

Referring now to the embodiment illustrated in FIG. 4, clamping assembly 128 may consist of a single clamp 138. As shown in this embodiment, clamp 138 comprises a central housing 139 designed to receive a handlebar. Clamp 138 further comprises four bore holes 140, 141, 142, 143 for receiving securing members 144, 145, 146, 147. In this embodiment, the bottom surface of platform 100 comprises inserts 148, 149, 150, 151 which receive securing members 144, 145, 146. 147 and attach clamp 138 to the underside of platform 100. Said inserts may be designed such that once engaged to the securing members, securing members are snugly engaged thereto and clamp 138 is affixed to the platform 100. For example, said inserts may be threaded and manufactured to receive a threaded screw or bolt.

In one embodiment, platform 1 is static and does not change position, for example, as shown in FIG. 4. In an alternative embodiment, platform 1 rotates about an axis of rotation defined by central bore 134 and pivot member 135 as shown in FIG. 1. Rotation of platform 100 may be unlimited or platform 100 may be prevented from rotation beyond a predetermined amount. For example, in the embodiment illustrated in FIGS. 8 and 10, platform 100 may rotate approximately 90° about pivot member 135 further rotation prevented through contact between rib 152 and ridge 153 (not shown in Figures). Thus, in this embodiment, as platform 1 rotates about pivot member 135 rib 152 engages ridge 153 and prevents further rotation of platform 100. This embodiment would allow a user standing directly behind or directly in front of the personal electronic device to adjust the screen from vertical view to landscape view with relative ease.

Referring now to FIGS. 1 and 4, the device may further comprise a cover 154 for covering the working components of platform 100 and sliding member 115 as well as for providing the personal electronic device a level, uniform surface upon which to rest.

The various components of the present invention may be made of materials including but not limited to metal, alloys of metal, steel, stainless steel, plastics, dense rubbers (synthetic and natural), and the like. For example, in relation to components made of plastic, polyethylene terephthalate (PET), high density polyethylene (HDPE), polyvinyl chloride (PVC), low density polyethylene (LDPE), polypropylene (PP), polystyrene (PS), polyvinylidene chloride (PVDC), high impact polystyrene (HIPS), acrylonitrile butadiene styrene (ABS), polycarbonate/acrylonitrile butadiene styrene (PC/ABS) and the like may be used for the purposes of this invention.

It will be understood by those of ordinary skill in the art that the solid materials may further comprise a single or plurality of antimicrobial agents comprising, for example, antibacterial, antiviral, and/or antifungal properties. Examples of commercially available antimicrobial agents that are suitable for the present disclosure include BARDAC®. 2050 and BARDAC® 2080 (based on dialkyl(C.sub.8-C.sub10)dimethyl ammonium chloride); BARDAC®. 2250 and BARDAC®. 2280 (didecyl dimethyl ammonium chloride); BARDAC®. LF and BARDAC®. LF 80 (based on dioctyl dimethyl ammonium chloride); BARQUAT® MB-50 and BARQUAT® MB-80 (based on alkyl dimethyl benzyl ammonium chloride); BARQUAT® MX-50 and BARQUAT® MX-80 (based on alkyl dimethyl benzyl ammonium chloride); BARQUAT® OJ-50 and BARQUAT® OJ-80 (based on alkyl dimethyl benzyl ammonium chloride); BARQUAT® 4250, BARQUAT® 4280, BARQUAT® 4250Z, and BARQUAT® 4280Z (based on alkyl dimethyl benzyl ammonium chloride and/or alkyl dimethyl ethyl benzyl ammonium chloride); and BARQUAT® MS-100 (based on myristyl dimethyl benzyl ammonium chloride), which are available from Lonza, Inc., Fairlawn, N.J.

Other anti-microbial agents that may be used in the present disclosure include halogenated diphenyl ethers like 2,4,4′-trichloro-2′-hydroxy-diphenyl ether (Triclosan® or TCS) or 2,2′-dihydroxy-5,5′-dibromo-diphenyl ether; phenolic compounds like phenoxyethanol, phenoxy propanol, phenoxyisopropanol, para-chloro-meta-xylenol (PCMX), etc.; bisphenolic compounds like 2,2′-methylene bis(4-chlorophenol) 2,2′-methylene bis(3,4,6-trichlorophenol) 2,2′-methylene bis(4-chloro-6-bromophenol), bis(2-hydroxy-3,5-dichlorophenyl)sulphide, and bis(2-hydroxy-5-chlorobenzyl)sulphide; halogenated carbanilides (e.g., 3,4,4′-trichlorocarbanilides (Triclocarbane or TCC); benzyl alcohols; chlorhexidine; chlorhexidine gluconate; and chlorhexidine hydrochloride. Other suitable antimicrobial compounds may include those supplied by Thomson Research Associates, Inc., such as Ultra-Fresh DM-50 or Silpure.

Inorganic antimicrobial agents may furthermore include metal elements, such as, silver, copper and/or zinc. Other organic compounds might include: Butyl BIT, DCOIT, OIT, OBPA, IPBC, TBT, TBZ, and Zinc pyrithione.

In accordance with one aspect of the present invention, a user desiring a more interactive shopping experience through the use of their personal electronic device may select a shopping cart with the apparatus described herein attached thereto. The user may place or slide a personal electronic device onto the platform. In embodiments comprising a sliding member, the user may press or pull the sliding member out just enough to fit the personal electronic device into the cradle and then release the sliding member wherein said brace comes into contact with the side edge of a personal electronic device helping to secure said device to the platform. If the embodiment allows for rotation and/or adjustment of the platform, the user may rotate or adjust the platform to maximize viewing and tactile interaction with the device. In the embodiment illustrated in FIG. 4, the same user may slide the personal electronic device over the button elements extending from the platform, compressing said button elements, and underneath the arms and buttons on brace. Compressing the button elements on the platform's surface and positioning the personal electronic device beneath the arms and buttons on brace further secures the device within the cradle.

While the present invention has been described herein with respect to the exemplary embodiments and the best mode for practicing the invention, it will be apparent to one of ordinary skill in the art that many modifications, improvements and subcombinations of the various embodiments, adaptations and variations can he made to the invention without departing from the spirit and scope thereof.

What is claimed is:

1. A support apparatus for a personal electronic device comprising: a platform; a clamp assembly fur attaching said apparatus to a transport carrier; and at least one support structure for securing said personal electronic device to said platform.

2. The support apparatus of claim 1 wherein said at least one support structure comprises a first side bracket and a second side bracket which form two walls of said platform.

3. The support apparatus of claim 1 wherein said support structure comprises a single side bracket which forms one of the walls of said platform.

4. The support apparatus of claim 1 wherein said single side brace comprises at least one arm extending from an upper edge of said brace for front surface support of said personal electronic device.

5. The support apparatus of claim 1 wherein said platform rotates about a central pivot member.

6. A support apparatus for a personal electronic device comprising a platform for supporting a personal electronic device, a means for securing a personal device to said platform, and a means of securing the apparatus to a transport carrier.

7. The support apparatus of claim 6 wherein said means for securing a personal electronic. device to said platform comprises at least one bracket.

8. The support apparatus of claim 6 wherein said means for securing a personal electronic device to said platform comprises a sliding member.

9. The support apparatus of claim 6 wherein said means for securing a personal electronic device comprises at least one bracket with an arm extending over the upper face of said personal electronic device.

10. The support apparatus of claim 6 wherein said means of securing the apparatus to a transport carrier comprises at least one clamp for engaging a transport carrier handlebar.

11. The support apparatus of claim 6 wherein said means of securing the apparatus to a transport carrier comprises at least one securing member which secures the clamp to said platform.

12. The support apparatus of claim 6 wherein said platform rotates about a central pivot member.

13. A method of supporting a personal electronic device to a transport carrier comprising the steps of: providing a support apparatus comprising a platform for supporting a personal electronic device, a means for securing a personal electronic device to said platform, and a means of securing the apparatus to a transport carrier; securing said apparatus to the handle of a transport carrier; placing a personal electronic device on said platform; and engaging the personal electronic device to the means for securing said personal electronic device in order to minimize unwanted movement of the personal electronic device.

14. The method according to claim 13 wherein said platform rotates about a central pivot member.

15. The method according to claim 13 wherein said means for securing a personal electronic device to said platform comprises at least one bracket.

16. The method according to claim 13 wherein said means for securing a personal electronic device. to said platform comprises a sliding member.

17. The method according to claim 13 wherein said means for securing a personal electronic device comprises at least one bracket with an arm extending over the upper face of said personal electronic device.

18. The method according to claim 13 wherein said means of securing the apparatus to a transport carrier comprises at least one clamp for engaging a transport carrier handlebar.

19. The method according to claim 13 wherein said means of securing the apparatus to a transport carrier comprises at least one securing member which secures the clamp to said platform.

20. The method according to claim 13 wherein said platform rotates about a central pivot member.
